(19) United States
(12) Patent Application Publication
(10) Pub. No.: US 2005/0054256 A1
(43) Pub. Date: Mar. 10, 2005

(54) Multi-layer fleece arrangement

(76) Inventor: Hans Georg Klein, Wehrheim (DE)

Correspondence Address: REED SMITH LLP, Suite 1400, 3110 Fairview Park Drive, Falls Church, VA, 22042, US

(21) Appl. No.: 10/931,131

(22) Filed: Sep. 1, 2004

(30) Foreign Application Priority Data
Sep. 10, 2003 (DE) 103 42 123.8

(51) Int. Cl. B32B 5/26; B32B 27/04; B32B 5/02; B32B 27/12; B32B 15/04; D04H 1/56

(52) U.S. Cl. 442/382; 442/400; 442/401; 442/394; 442/417; 442/102; 442/118

(57) ABSTRACT

The invention concerns a fleece arrangement, in particular for absorptive hygiene articles. The fleece arrangement is structured as a multi-layer compound and comprises at least one carrier layer (9) and one cover layer (3, 4). According to the present invention the fleece arrangement has a film comprising hot-melt film (10). This hot-melt film (10) acts either as carrier for super absorber polymer (8) arranged in certain places on the surface of the hot-melt film (10), or the hot-melt film (10) itself forms the carrier layer of the fleece arrangement. Further, the invention concerns a manufacturing process for such a multi-layer fleece arrangement. With the inventive fleece arrangement important properties such as thickness, water vapour permeability, fluid density, and fluid uptake, mechanical load capacity and wear comfort of absorptive hygiene articles, in particular slip inserts or napkins, can be decisively improved. At the same time the manufacturing costs of the fleece arrangement are not increased due to the invention in spite of improved product properties, rather they can partially even be reduced.

The invention relates to a multi-layer fleece arrangement, in particular for absorptive hygiene articles, according to preamble of claim 1 or the preamble of claim 4. The invention further concerns a process for producing a fleece arrangement as claimed in claim 24 or claim 25.

Fleece arrangements of the abovementioned type are used for example, though certainly not exclusively, for hygiene articles, such as for example for slip inserts, napkins or incontinence pads. Such fleece arrangements comprise several layers of functional tissue or fleeces and their task is generally to be capable of absorbing the greatest possible quantity of fluid, while having the least possible intrinsic weight and the least possible thickness. At the same time it should be ensured also that with high fluid uptake the fluid does not escape, most of all not if pressure is exerted on the fleece arrangement.

The nonwoven material normally used as absorption layer in generic fleece arrangements such as for example hydrophilic airlaid fleeces, require surface weights of up to more than 200 g/m² in order to satisfy the required absorption and storage capability for fluids. This leads to relatively thick hygiene products, which have reduced wear comfort.

From the prior art it is also known to incorporate in generic fleece arrangements so-called super absorber polymers, such as for example cross-linked polyelectrolytes or forming polyacryl acid esters. Due to their extreme swelling capacity on contact with fluid the super absorber polymers are particularly suited to satisfy the existing high demands of specific fluid uptake in the hygiene area.

In products known from the prior art the super absorber polymer is however mostly placed in a layer of the fleece arrangement, which generally takes place by insufflating super absorber polymer powder into the basic material of the corresponding fleece layer. However there is often inadequate anchoring of the super absorber polymer particles in the fleece layer and thus unwanted dusting of super absorber polymer particles from the fleece layer.

The document WO 00/39379 A2 suggests, as a solution to this problem, providing particles in the meltblown fleece by insufflating and adding a heated SAP/NaHCO₃ mixture to the meltblown fibre process for better anchoring of the super absorber polymer. The drawback to this is however the expensive technical production and the excessively strong binding of the super absorber polymer particles to the fleece fibres, thus reducing the free surface of the particles and also diminishing the absorption capacity of the super absorber polymer.

Apart from the required high fluid uptake, which can be produced for example by means of the described super absorber polymer, with the abovementioned hygiene articles it is however also preferred that the hygiene articles are skin-friendly because of direct skin contact and have high wear comfort. Also, the trend meanwhile tends to products open to steam, i.e. respiratory-active, with which wear comfort can be substantially improved. On the other hand such hygiene products should also not only definitely not have a wet feel with the absorption of moisture, but—in spite of the desired respiratory activity—there should as far as possible also be no escaping of moisture for example at the edges and in particular on the rear of the product.

PE films, which are designed partially microporous, are frequently used to achieve waterproofness on the rear side of generic hygiene products in fleece arrangements known from the prior art to ensure a certain respiratory activity. However the result of this film-like material is that the desired textile character, or the desired soft grip on the material surface, is clearly worsened. This disadvantageous property shows up in particular in the microporous PE films known from the prior art, which are often enriched with high portion of fillers, for example with CaCO₃, to achieve steam permeability.

Against this background it is the task of the present invention to provide a fleece arrangement or a process for manufacturing a fleece arrangement, by which the abovementioned disadvantages are overcome. In particular the fleece arrangement should be suited for cost-effectively produced hygiene products with high wear comfort, high absorbency and high escape security.

This task is solved by a fleece arrangement according to the teaching of claim 1 or according to the teaching of claim 4 and by a manufacturing process for a fleece arrangement having the features of claim 24 or having the features of claim 25.

Preferred embodiments are the object of the independent claims.

The fleece arrangement according to the present invention is structured in a manner first known per se as a multi-layer compound, whereby the multi-layer compound comprises at least a carrier layer and a cover layer. According to the invention the fleece arrangement however first comprises a film made of a hot-melt film (hot-melt).

In the process this hot-melt film acts either as carrier for particle-shaped super absorber polymer, whereby the super absorber polymer is arranged selectively or in certain places on the surface of the hot-melt film, or the hot-melt film itself already forms the carrier layer of the fleece arrangement.

Thanks to the sealing effect of the hot-melt adhesive film applied directly to the carrier layer and selectively coated with super absorber polymer, or even forming the carrier layer the PE film on the rear side of the fleece arrangement often used according to the prior art can be dispensed with, without any losses in function having to be made with respect to fluid uptake or fluid density of the fleece arrangement.

Since the hot-melt adhesive film can also be kept extremely thin, the mechanical properties and the desired soft grip on the material surface of the support fleece are almost not influenced or altered with use of a support fleece. On the one hand this opposes optimal processing capacity of the fleece arrangement during manufacture of hygiene articles, and on the other hand considerably improves the wear comfort of such hygiene articles. In addition the hot-melt film is applied to the support fleece in the hot state, resulting in a flat, homogeneous connection between the hot-melt adhesive film and the support fleece.

The support fleece in this case is preferably spunbonded, needle punched nonwoven, or micro-fibre fleeces (meltblown) or water-needled fleeces of polypropylene, polyethylene terephthalate or polyethylene, particularly preferably spunbonded fleeces made of polypropylene or low-density or high-density polyethylene. The surface weight of the support fleece is preferably in the region of 8 to 80 g/m² when such a spunbonded fleece is used. Also, these minimal surface weights contribute to the desired thinnest final product and compared to the prior art enable particularly soft, grip-friendly hygiene products with high wear comfort.

If the hot-melt adhesive film is processed without additional carrier layer—in other words where the hot-melt adhesive film itself forms the carrier layer—on account of the total omission of support fleeces or the like this results in particular in extremely favourable manufacturing costs for the fleece arrangement, without fluid uptake or fluid density of the fleece arrangement being impaired thereby. This applies in particular also whenever the fleece arrangement contains super absorber polymer, and thus enables a particularly high fluid uptake.

If so-called contact hot-melt is used for the hot-melt film, as is provided according to an embodiment of the invention, then the hot-melt film layer can take on the added task even more of preventing the hygiene product from going off centre when the hygiene product is worn by adhering to the inside of clothing.

An arrangement of super absorber polymer particles on the surface of the hot-melt film enables extremely secure binding of the super absorber polymer particles, so that the problem of unwanted dusting of super absorber polymer particles is eliminated. At the same time the surface of the super absorber polymer particles adhering to the hot-melt adhesive film is available almost fully for absorption of fluid compared to the prior art. A particular advantage of embedding or adhering of the SAP powder on the hot-melt film is that the fleece arrangement also remains stable after absorption of large quantities of fluids and even when a cover layer is damaged there is practically no leak of SAP gel.

In addition, however, a in certain places, selective arrangement of the super absorber polymer particles on the hot-melt adhesive film enables extremely advantageous control of the fluid uptake in hygiene products, made from the fleece arrangement. The super absorber polymer particles can be arranged in the surface of the hot-melt adhesive film for example such that the greatest quantity of super absorber polymer comes to rest in those areas of the hygiene articles, in which the greatest quantity of fluid accumulates and is to absorbed, according to experience.

The starting material and material properties of hot-melt film or support fleece are at first even inconsiderable for the realisation of the invention, as long as the desired anchoring effect for the super absorber polymer particles or replacement of the carrier layer can be brought about by the hot-melt film. In accordance with a preferred embodiment of the invention however the materials used for the carrier layer and/or for the hot-melt film are hydrophobic.

The result of this is that the escape of fluid on the rear side of hygiene products, made from the fleece arrangement, is made considerably more difficult or is prevented. On the one hand the hot-melt adhesive film already forms an effective fluid barrier independently of the material used for the hot-melt film, a behaviour, which is on the other hand reinforced even more by the use of a hydrophobic material for the hot-melt film and/or for the carrier layer. With particularly high demands on the density of hygiene products, as provided by a further embodiment of the invention, a material can be used for the hot-melt film, which is permeable to steam.

Tests have shown that a fleece arrangement with particularly advantageous properties is obtained when ethyl vinyl acetates, polyamides, polyvinyl alcohols or polyurethanes are used as material for the hot-melt adhesive film, as is also provided by a further embodiment of the invention.

Hygiene products with particularly good wear comfort can be manufactured from the fleece arrangement, as is provided according to a further embodiment of the invention, if the hot-melt adhesive film is open to diffusion, i.e. permeable to steam. In this way after the carrier material is coated with the hot-melt adhesive film a material path is obtained, which on the one hand reliably prevents fluids and wetness from leaking in or out, on the other hand however enables removal of the vaporous body moisture and its waste to the ambient air.

It has been shown, as is also provided according to a further embodiment of the invention, that a hot-melt adhesive film open to diffusion is in particular obtained if the material for the hot-melt adhesive film has hydrophilic constituents and a surface tension of ≦20 mN/m originating from the hydrophilic constituents.

The hydrophilic constituents ensure that the hot-melt adhesive film receives the desired permeability properties for water molecules, i.e. for water vapour, whereby however the closeness relative to fluids remains intact. At the same time it has been proven that particularly advantageous properties of a fleece arrangement can be adjusted in particular when elastomers based on polytetramethylene oxide, comonomers of polypropylene oxide and polyethylene oxide or hydrophilic polymer emollients are used for the hydrophilic constituents of the hot-melt adhesive film. Above all the latter are distinguished by the fact that they are particularly cost-effective.

A further advantage of the invention is that fluid-tight layers of almost any thickness can be created already through the principle of forming a fluid-tight layer in the form of hot-melt. However, the coating weight of the hot-melt film coating is preferably between 5 to 50 g/m² depending on specific use. The resulting hot-melt adhesive film enables the desired moisture barrier, however at the same time is so thin that if a support fleece is used the soft grip on the material surface of the support fleece is practically not impaired. In addition, the resulting hot-melt adhesive film is not inconsiderably thinner than the PE films used according to the prior art; this not only improves the grip friendliness of the hygiene products, but also contributes to the desired minimal surface weight of the fleece arrangement.

A further specific advantage of the layer of the fleece arrangement formed by a hot-melt adhesive film is that the hot-melt adhesive film not only produces a homogeneous compound with the support fleece when a support fleece is used, but also can be employed for the task of lamination or adhesion with the cover layer. The latter also applies whenever the hot-melt film takes over the task of the support layer.

The cover layer comprises, according to a preferred embodiment of the invention, a hydrophilic micro-fibre fleece, which fits in with the rapid and basic absorption of moisture through the cover layer. For the hydrophilic microfibre fleece thus directly adjoining the collection layer, absorption layer or the super absorber polymer of the fleece arrangement provides a rapid and large-surface distribution of the absorbed fluid when fluid enters due to its strong wick effect, such that when fluid enters the largest possible surface area of the collection layer, absorption layer or of the super absorber polymer of the fleece arrangement is wet or activated.

In accordance with a further preferred embodiment of the invention the cover layer consists of a so-called SM compound, comprising a layer of hydrophilic spunbonded fleece, made for example from polypropylene or polyethylene, with a preferred surface weight of 8 to 80 g/m², and a layer of hydrophilic meltblown, for example of polypropylene, with a preferred surface weight of 10 to 100 g/m². Here the meltblown again takes on the task of rapid and large-surface distribution and possibly also storage of incoming fluid.

The spunbonded fleece-cover layer connected to the meltblown here particularly satisfies mechanical and decorative tasks and is also suited particularly well for direct skin contact.

In accordance with a further embodiment of the invention the cover fleece or the surface of a multi-layer cover layer arranged on the hot-melt adhesive film is also equipped particularly skin-friendly by softeners containing oil, wax or fat. This is an advantage with direct skin contact in particular for hygiene articles such as for example, though in no way exclusively, slip inserts.

According to a further preferred embodiment of the invention first projecting edges of the carrier layer or the cover layer of the fleece arrangement are folded around the edges of the fleece arrangement and thus form at least in certain places an edge envelope around the outer edges of a hygiene product made from the fleece arrangement. In this way the fleece arrangement of the hygiene product is on the one hand mechanically stabilised and the individual layers of the fleece arrangement are additionally fixed on one another or are connected to one another, thus facilitating and improving handling of the product made from the fleece arrangement.

In particular when the carrier layer is enveloped in this way fluid is effectively prevented from escaping through the hydrophobic carrier layer also at the edges of the hygiene product. This applies in particular in comparison to the prior art, in which instead the hydrophilic cover layer is enveloped around the edges of the hygiene product, likewise improving handling of the product, however per se makes no substantial contribution to safety against fluid escape. Along with the selectively applied super absorber polymer however in the present invention also enveloping the cover layer forms effective protection against fluid escape. This is based on the fact that the enveloped cover layer in particular takes on the task also important for escape protection of securely holding together the individual layers of the fleece arrangement, while lateral escape is prevented by no super absorber polymer being present in the edge regions of the fleece arrangement.

In accordance with a further embodiment of the invention a natural product is used for the super absorber polymer at least proportionally, in particular from the crushed fruit of the Johannes bread tree. A thickening agent, carubin, otherwise already widely technologically used, can be extracted from the kernels of the fruit of the Johannes bread tree. It contains polysaccharides, albumin and flavonoids. Carubin swells five times as much as starch and is already utilised as a binder and stabiliser in a plurality of foodstuffs. The extremely high swelling capacity also predestines carubin for use as a super absorptive material in a fleece arrangement.

According to further, likewise preferred embodiments of the invention active carbon and/or coked bamboo in pulverised form is added to the super absorber polymer. In this way the smell absorption of the fleece arrangement can be improved above all, for example for the case, where moisture is stored for periods lasting several hours in the fleece arrangement. The smell absorption of a fleece arrangement according to this embodiment is hereby based on the particularly good chemical adsorption capacity of such high-porosity and considerably pure carbon, in particular with respect to unwanted dyes, taste and olfactory substances.

Furthermore, the invention concerns a process for manufacturing an absorptive fleece arrangement. The inventive process according to the teaching of patent claim 24 or 25 comprises the following procedural steps.

First, in a first procedural step a hot-melt film is applied to a carrier layer. Next, in a further procedural step super absorber polymer is applied in powder form directly to the still adhesive hot-melt film selectively or only in certain surface areas of the hot-melt film.

In a further procedural step a cover layer is then applied to hot-melt film and super absorber polymer powder. Finally, in a further procedural step the fleece arrangement is cut to size and the different layers of the fleece arrangement are connected to one another.

Using the inventive process highly absorptive fleece arrangements with particularly advantageous properties can be made cost-effectively for use. This is first connected with the fact that the hot-melt film fulfils several different functions with the inventive process at the same time.

The hot-melt film on the one hand thus forms a barrier for fluids and thus allows the particularly skin-friendly and grip-sympathetic micro-fibre fleeces to be used for the support layer instead of the synthetic films frequently used in the prior art.

The hot-melt film also acts to anchor the applied super absorber polymer particles. In comparison to the prior art initially described this leads to mechanically particularly stable fleece arrangements capable of bearing, which are not inclined to dust super absorber polymer powder and also exhibit no tendency to leak after absorption of large quantities of fluids. Finally, the hot-melt film can also still assume the task of adhering the individual material layers under one another, whereby even further stabilising of the compound can be achieved by penetration of the hot-melt film between the fibres laid on the surface of the individual material layers.

Fleece arrangements with particularly advantageous usage properties for use in hygiene products can be manufactured with the inventive process. This is connected with selective application of the super absorber polymer powder to the still molten or adhesive hot-melt film. For in this way the majority of the super absorber polymer powder can be applied to those surface areas of the fleece arrangement, in which the greatest quantity of fluid occurs or must be absorbed according to experience.

In addition, in this way for example the edge regions of a hygiene product can be kept extensively free of the coating of super absorber polymer powder, so that in these regions also there is no storing of appreciable quantities of fluid. Rather the accumulating fluid is directed thus into the centre of the absorption area and stored there. This configuration additionally contributes to the discharge safety of the product. Because in this way projecting edge regions of the hygiene product likewise contain no super absorber polymer, the material of these edge regions can easily be recycled after excision as compared to the prior art.

A further inventive process for manufacturing an absorptive fleece arrangement comprises in a first procedural step applying at least a layer of hot-melt film to a separating paper. In a further procedural step a cover layer is then applied to the hot-melt film. Finally, in a further procedural step the layers of the fleece arrangement are cut to length and joined together.

The advantage of this manufacturing process in particular is that high-quality absorptive fleece arrangements can thus be manufactured extremely cost-effectively, since the hot-melt film here also takes on the task of support layer in the absence of otherwise additionally necessary layers.

If in addition a contact hot-melt is used for the hot-melt film, one and the same hot-melt film can also assume the task of the adhesive strips, which prevent the hygiene product from moving off centre on the finished hygiene product by adhering to the inside of clothing.

Such a fleece arrangement with a hot-melt film as support layer may contain a further layer as constituent, or super absorber polymer as a coating applied directly to the still adhesive hot-melt film, in order to improve the absorption properties of a hygiene product made form the latter. The super absorber polymer is preferably particulate and is arranged on the hot-melt film particularly preferably selectively only in certain places.

First, it is not essential for the invention, in which way selective application of the super absorber polymer particles to the melt of the hot-melt film is carried out, as long as the provided uneven distribution of the super absorber polymer particles is performed at the required short cycles or high throughput rates.

In accordance with a particularly preferred embodiment of the invention however selective application of the super absorber polymer particles is done by a pressure roller, in particular an engraved roller. This method borrowed in principle from printing methods is extremely advantageous insofar as almost any high throughput rates—rates of up to almost 300 metre/min are usual here—or almost any short cycles can be achieved.

At the same time the depressions of the engraved roller corresponding to the desired distribution of the super absorber polymer powder are filled from a reservoir with super absorber polymer powder, whereby excess quantities of powder are stripped off by a doctor blade and recycled. The super absorber polymer powder remaining in the engraving is then transferred indirectly or directly in the desired surface distribution to the still sticky hot-melt film.

In accordance with a further embodiment of the invention selective application of super absorber polymer particles is carried out by electrostatic spraying. In this way also any surface distributions of the super absorber polymer powder can be achieved when applied to the hot-melt film.

The invention is carried into effect independently of which type of cover layer is arranged on the hot-melt film. In the simplest scenario the cover layer may comprise a hydrophilic fibrous fleece for example, which already provides good fluid uptake and fluid distribution. According to a further preferred embodiment of the invention the cover layer however is in the form of a hydrophilic SM compound made of spunbonded fleece and meltblown.

This results in particularly absorptive fleece arrangements, because on account of its strong capillary or wick effect the meltblown can quickly distribute soaked-in fluids over a large surface, by means of which a large surface area for example of the super absorber polymer powder can quickly be wetted or activated. Here the spunbonded fleece in particular takes on the task of mechanical stabilising and limiting the meltblown on the material surface.

In accordance with a further embodiment of the invention in an additional procedural step projecting edge regions of the carrier layer or of the cover layer are folded around the corresponding edge regions of the other layers of the fleece arrangement and thus form an edge envelope of the hygiene product made from the fleece arrangement.

In this way the fleece arrangement forming the hygiene product can on the one hand be mechanically stabilised and the individual layers of the fleece arrangement can additionally be fixed to one another or connected to one another. Thereby handling of the product made from the fleece arrangement is improved and made easier. On the other hand in particular by enveloping the hydrophobic carrier layer in this way fluid is also securely prevented from escaping at the edges of the hygiene product.

For the invention it is not significant in which way the mechanical joining of the layers of the fleece arrangement is performed. In accordance with a preferred embodiment the layers of the fleece arrangement however are connected by calendering, the particular advantage of which is that it can be performed in-line at full path speed.

A further embodiment of the inventive process provides that in further procedural steps hot-melt contact adhesive and separating paper, for example silicon paper, is applied to the rear side of the support layer. In this way the previously produced hygiene product can be provided with the adhesive strips required for fixing the hygiene product when applied, and at the same time the adhesive strip can obtain the necessary protective covering.

It is also not important for the nature of the invention as to how the technical transformation of the inventive process proceeds. Thus the inventive process can be carried out for example discontinuously or offline. In accordance with a preferred embodiment of the invention however all procedural steps are performed in the regulated or continuous inline process. In this way a particularly high throughput can be accomplished with simultaneously high reproducibility of the quality parameters of the fleece arrangement.

The invention will now be explained in greater detail by means of diagrams illustrating only embodiments, in which:

FIG. 1 shows the elementary functioning of a fleece arrangement according to the prior art in a schematic lateral section not true to scale;

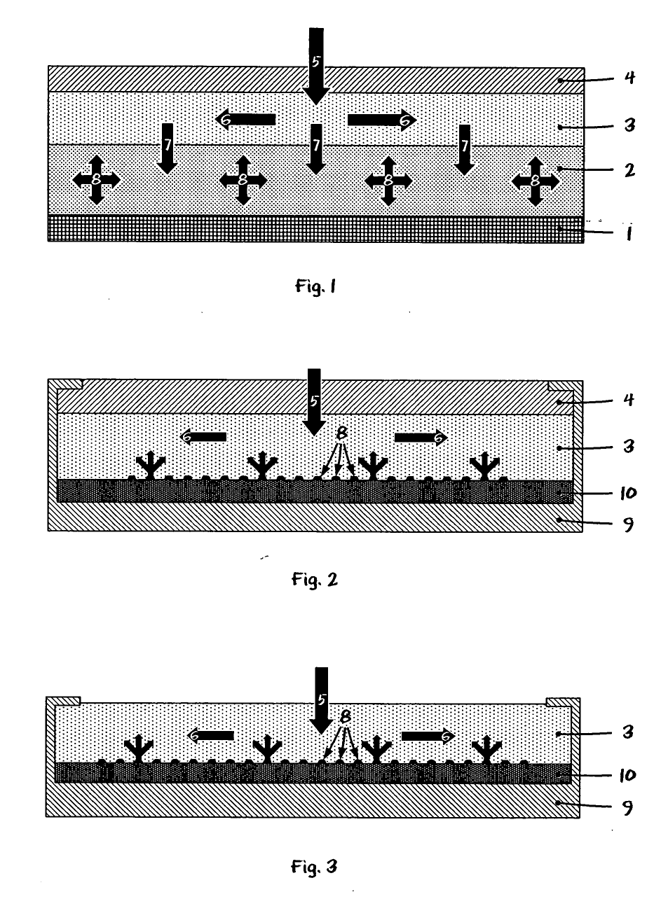

FIG. 2 shows the elementary structure and the elementary functioning of a fleece arrangement according to an embodiment of the present invention in an illustration corresponding to FIG. 1;

FIG. 3 shows the elementary structure and functioning of a fleece arrangement according to a further embodiment of the present invention in an illustration corresponding to FIGS. 1 and 2;

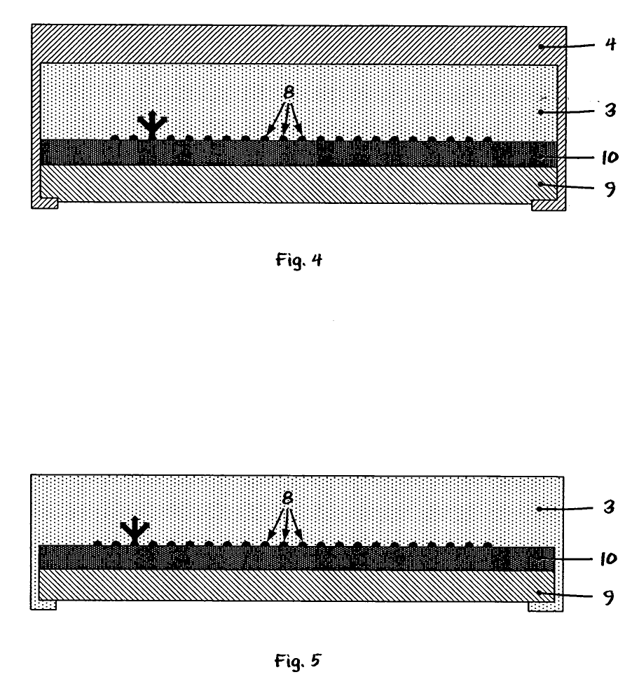

FIG. 4 shows the elementary structure of a fleece arrangement according to an alternative embodiment of the present invention in an illustration corresponding to FIGS. 1 to 3;

FIG. 5 shows the elementary structure of a fleece arrangement according to a further embodiment of the present invention in an illustration corresponding to FIGS. 1 to 4;

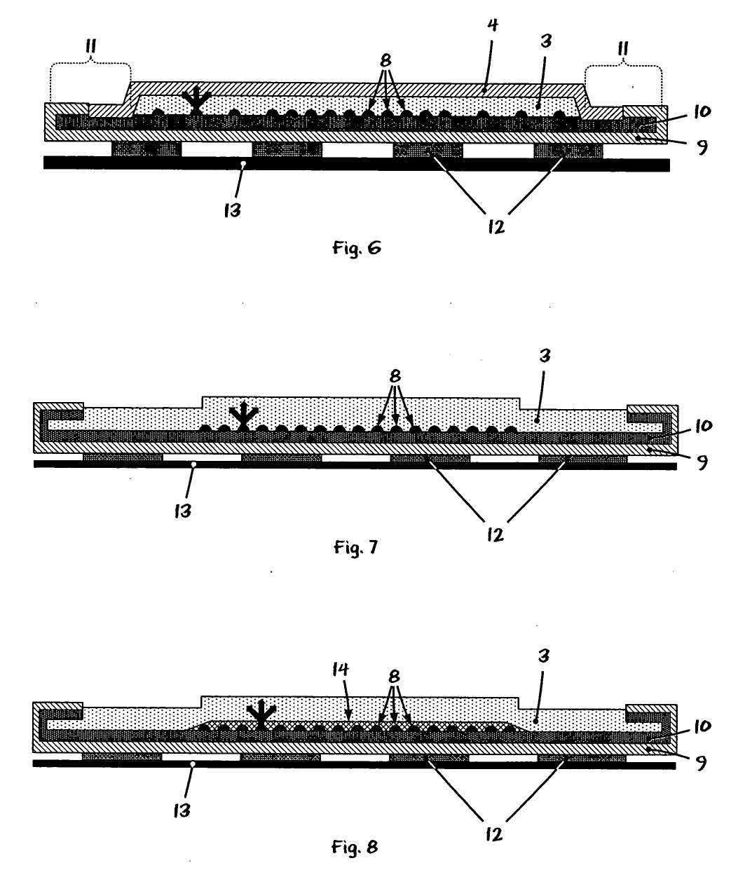

FIG. 6 shows an embodiment of a fleece arrangement in an illustration corresponding to FIGS. 1 to 5;

FIG. 7 shows an embodiment of a fleece arrangement with meltblown as a cover layer in an illustration corresponding to FIGS. 1 to 6;

FIG. 8 shows an embodiment of a fleece arrangement with a dryblend made of super absorber polymer and hot-melt in an illustration corresponding to FIGS. 1 to 7;

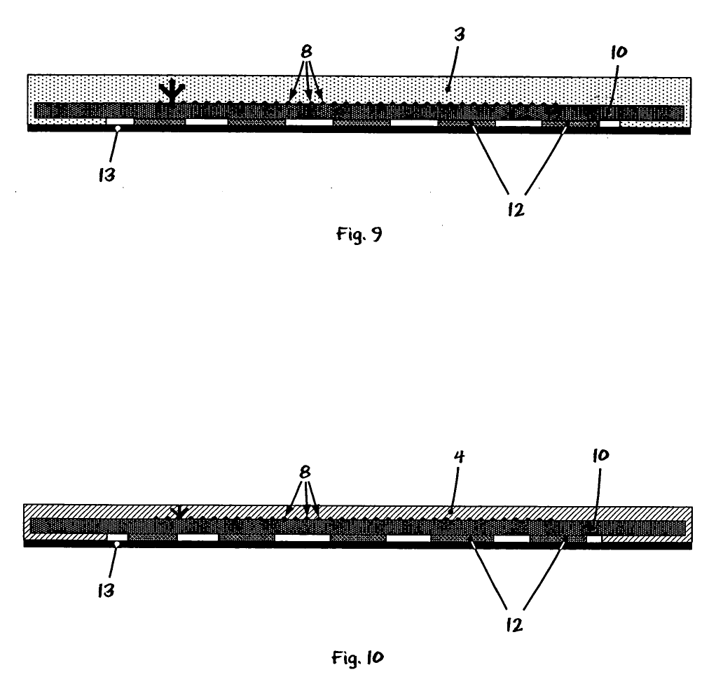

FIG. 9 shows a further embodiment of a fleece arrangement with meltblown as cover layer and hot-melt as carrier layer in an illustration corresponding to FIGS. 1 to 8;

FIG. 10 shows a further embodiment of a fleece arrangement with spunbond as cover layer and hot-melt as carrier layer in an illustration corresponding to FIGS. 1 to 9;

FIG. 11 shows an alternative fleece arrangement with hot-melt as carrier layer in an illustration corresponding to FIGS. 1 to 10;

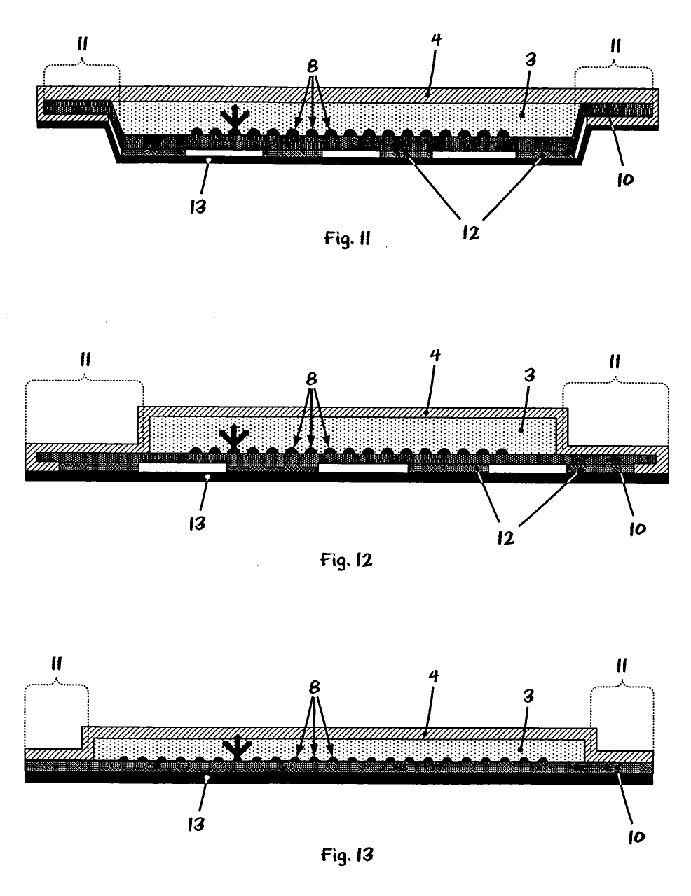

FIG. 12 shows a further fleece arrangement with hot-melt as carrier layer. in an illustration corresponding to FIGS. 1 to 11;

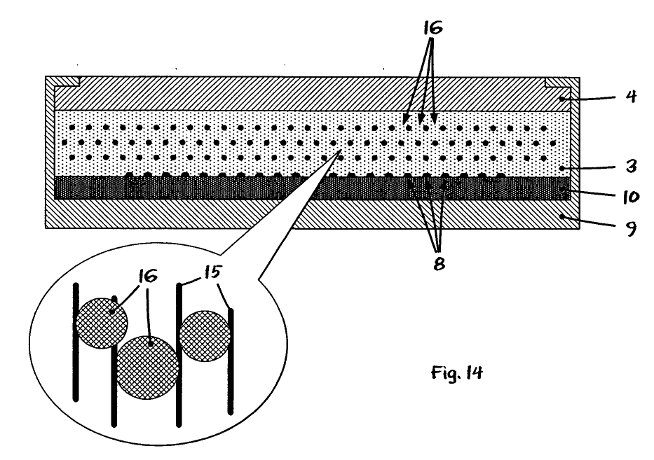

FIG. 13 shows a fleece arrangement with contact hot-melt as carrier layer in an illustration corresponding to FIGS. 1 to 12; and

FIG. 14 shows a fleece arrangement with additional SAP powder inside the area of the meltblown layer in an illustration corresponding to FIGS. 1 to 13.

In FIG. 1 the cross-section of a multi-layer fleece arrangement is illustrated in a schematic illustration, as is known in principle from the prior art.

First, the diagram-related subjacent support layer 1 is evident, which according to the prior art in general comprises a microporous polyethylene film. Arranged directly on the support layer 1 is an absorption core 2, which comprises a highly absorptive material, for example a material layer containing super absorber polymer. Located above the absorption core 2 is the collection layer 3, which acts as rapid absorption and fluid distribution inside the plane of the fleece arrangement. The collection layer 3 comprises in general a stacking fibre fleece or meltblown. Furthermore, the fleece arrangement comprises the cover layer 4, which is generally in the form of a hydrophilic spunbonded fleece permeable to fluids.

The principle of fluid uptake and fluid distribution and storage in the fleece arrangement is illustrated in FIG. 1. The arrow designated with reference numeral 5 stands for a quantity of fluid applied to the cover layer 4, which is immediately sucked right through the cover layer 4 on account of the open-pored character of the cover layer 4 and is first suctioned by the collection layer 3 on account of the strong capillary or wick effect of the collection layer 3. Likewise on account of the strong wick effect the suctioned quantity of fluid 5 is distributed horizontally inside the surface of the collection layer 3 according to the diagram, as illustrated by the arrows designated with reference numeral 6.

Following the horizontal distribution 6 of the penetrating fluid 5 the latter is forwarded from the collection layer 3 to the absorption layer 2, as indicated by the arrows designated with reference numeral 7. Inside the absorption layer 2 the quantity of fluid 5 is finally absorbed by activating, expansion and gel formation of the super absorber polymer contained in the absorption layer 2 and bound as gel, as the arrows 8 indicating expansion of the super absorber polymer point out.

As explained at the outset, this structure of the fleece arrangement known from the prior art has various drawbacks, examples of which are in particular the defective wear comfort of hygiene products constructed in such a manner, or the defective grip friendliness of the polyethylene film 1 showing the support layer, the complicated structure, the defective combining of the individual layers and the defective anchoring of the super absorber polymer 8 inside the absorption layer 2.

In addition to this the tendency of the fleece arrangement illustrated in FIG. 1 to lateral fluid escape is also a disadvantage. On the one hand this is connected to the fact that with the fleece arrangement illustrated in FIG. 1 no lateral barrier measures for preventing lateral fluid escape are taken. On the other hand the tendency to fluid escape is also connected to the fact that all layers of the fleece arrangement according to FIG. 1 have a homogeneous structure, which is why centrally entering fluid 5 is also conveyed to the sides of the fleece arrangement, where it can escape, if necessary.

These disadvantages are eliminated by the fleece arrangement incorporating an embodiment of the present invention illustrated in FIG. 2. The fleece arrangement according to FIG. 2 likewise has a support layer 9. First, compared to the prior art and according to FIG. 2 the support layer 9 however is now in the form of a respiratory-active fibre fleece, as is the cover layer 4, which in particular already considerably improves the wear comfort and the “look-and-feel” of such hygiene products.

Furthermore, the required fluid density in the fleece arrangement according to FIG. 2 is ensured by a fluid-tight membrane 10 applied directly to the support layer 9, present in the form of a hot-melt film layer 10. Products marketed by Wetzel, Herford, known under the brand names Pergitex 99932 or Pergitex 23535, have proven themselves as start materials for the hot-melt layer 10. The hot-melt layer 10 is preferably applied with a curtain slot nozzle, whereby curtain coating nozzles marketed by Inatec, Langen-feld in particular have proven suitable for this purpose.

Applied directly to the hot-melt layer 10 is super absorber polymer 8 in the form of finely distributed powder particles. There is in particular the advantage that the super absorber polymer 8 is connected via the hot-melt film 10 to the support layer 9 or spatially anchored, which makes a harmful contribution to the mechanical stability, fluid escape security and thus the performance capability of a hygiene product so structured.

Arranged above the hot-melt film 9 or the super absorber polymer 10 again according to the diagram is a collection layer 3, which acts as rapid suctioning and superficial distribution 6 of a quantity of fluid 5 applied to the fleece arrangement. Following this the quantity of fluid 5 is bound by activation, expansion and gel formation of the super absorber polymer spheres 8 in the fleece arrangement according to FIG. 2, as indicated by the triple arrows illustrating expansion of the super absorber polymer 8.

In addition however the super absorber polymer powder 8 is applied in the fleece arrangement according to FIG. 2 only in certain places to the hot-melt layer 10, so that there is a higher concentration of super absorber polymer 8 in the middle region of the fleece arrangement than in the edge regions. In other words this means that the super absorber polymer 8 with the fleece arrangement according to FIG. 2 is arranged is primarily in those regions of the hygiene product, in which according to experience the greatest quantity of fluid 5 accumulates and has to be absorbed. For this very reason also a tendency to lateral discharge of a hygiene product designed to FIG. 2 is considerably reduced, since fluid 5 is barely taken up and stored in the edge regions of the hygiene product. Rather, the quantity of fluid is drawn into that central region of the hygiene product, in which previously there was selective application of the super absorber polymer powder 8.

In addition, selective application of the super absorber polymer powder 8 to the hot-melt film 10 results in cut waste of the meltblown fleece 3, which accumulates when the fleece arrangement is trimmed to size, being easily recycled, since it contain no super absorber polymer powder 8.

The cover layer 3, 4 of the fleece arrangement according to FIG. 2 can preferably comprise a so-called SM compound, which is present for example as a half-finished product made of spunbonded fleece 4 and meltblown 3. In this context a further advantage of the fleece arrangement according to FIG. 2 comes in useful, which is connected to the multifaceted function of the hot-melt film 10. The hot-melt film 10 serves both to produce the fluid-tight layer 10 of the fleece arrangement as well as the mutual anchoring of support layer 9, super absorber polymer 8 and SM-cover layer 3, 4. Thereby this anchoring of the different layers of the fleece arrangement enables the manufacture of mechanically particularly more resilient and thus particularly high-grade hygiene products.

A further advantage of the fleece arrangement according to FIG. 2 is that the support layer 9 preferably designed as hydrophobic fleece is guided around the edges of the fleece arrangement or around the edges of a resulting hygiene product and that additional effective discharge protection is given at the edges of the product.

FIG. 3 shows structure and functioning of a fleece arrangement according to a further embodiment of the invention.

Illustrated is a structure of the fleece arrangement, which equates extensively with that of the fleece arrangement according to FIG. 2. The difference to the fleece arrangement according to FIG. 2 is that with the fleece arrangement according to FIG. 3 the cover layer is formed only by a single layer of a hydrophilic meltblown 3. On the one hand this serves the desired minimal overall strength of the fleece arrangement or of the resulting hygiene product. On the other hand there are fewer work steps associated with manufacturing the fleece arrangement according to FIG. 3, which leads to cost-effective manufacturing capacity and an accordingly favourable price point of a resulting hygiene product.

FIG. 4 shows the elementary structure of an alternative embodiment of the fleece arrangement according to the present invention. The layer structure of the fleece arrangement is evident from FIG. 4, which corresponds to a large extent to the layer structure of the fleece arrangement according to FIG. 2. In particular this applies, when the diagram is viewed from top to bottom, for the sequence of support fleece 9, hot-melt film 10, selective super absorber polymer coating 8 and the cover layer 3, 4 comprising a SM compound. In comparison to the fleece arrangement according to FIG. 2 with the fleece arrangement according to FIG. 4 it is not the support fleece 9, but the spunbond layer 4 of the SM cover layer 3, 4 which is wrapped around the edges of the fleece arrangement.

The same applies also for the difference between the fleece arrangement according to FIG. 5 and the fleece arrangement according to FIG. 3. Also in both these fleece arrangements in any case the same layer structure is present. Also the fleece arrangement according to FIG. 5, as too the fleece arrangement according to FIG. 3, dispenses with a cover layer 4 of spunbound in favour of cost-effective production capacity and a lesser layer thickness.

Rather, with the fleece arrangement according to FIG. 5 as well as with the fleece arrangement according to FIG. 3 the cover layer is formed by the meltblown layer 3 itself. With the fleece arrangement according to FIG. 5 the meltblown layer 3 also forms the lateral delimitation of the fleece arrangement or of the hygiene product, in that the meltblown layer 3 is wrapped at the edges of the product around the further layers of the fleece arrangement, namely hot-melt 10 with super absorber polymer 8 and support fleece 9.

Although the spunbound layer 4 of the SM cover layer 3, 4 (FIG. 4) or the meltblown layer 3 (FIG. 5) in any case is hydrophilic, and thus not hydrophobic as is the support fleece 9, with the fleece arrangements according to FIGS. 4 and 5 or with resulting hygiene products all the same good and effective discharge protection can also be achieved at the edges of the product. This is connected in particular to the fact that the super absorber polymer 8 is applied selectively, as shown in FIGS. 4 and 5, by super absorber polymer particles 8 being arranged only in the central region of the surface of the fleece arrangement, and not in the edge region of the fleece arrangement or of the hygiene product.

The improvement in the composition of all layers of the fleece arrangement or of the hygiene product by the laterally wrapped cover layer 4 or 3 (FIGS. 4 and 5) or carrier layer 9 (FIGS. 2 and 3) is naturally independent of whether the hydrophilic cover layer 4 or 3 or the hydrophobic carrier layer 9 grips round the layers of the fleece arrangement.

FIGS. 6 to 13 show further embodiments of fleece arrangements or hygiene products in a likewise schematic illustration, not true to scale, whereby the illustration of FIGS. 6 to 13 however was selected as less abstract than the illustration of FIGS. 1 to 5 and therefore approaches the actual design of the respective hygiene products.

FIG. 6 shows a fleece arrangement or a hygiene product, which again comprises support fleece 9, hot-melt layer 10 with super absorber polymer particles 8 as well as meltblown-collection layer 3 and spunbound cover layer 4. Here the support fleece 9 is guided around the lateral edges of the hygiene product. This lateral enveloping of the support fleece 9 together with selective application of the super absorber polymer 8 and together with the meltblown collection layer 3 not covering the whole width of the product, which leads to tapering 11 of the spunbound cover layer 4, results in extremely efficacious discharge protection on the lateral edges of the product. Additionally, this results in particular in a hygiene product, which has high user-friendliness and particularly good stability in handling in the dry and in the moist state on account of the homogeneous compound of layers with one another.

What is more, the fleece arrangement or the hygiene product according to FIG. 6 is provided with a punctiform or strip hot-melt adhesive coating 12 on the rear side of the support fleece. The hot-melt adhesive 12 arranged there serves to fix the hygiene product on the inner face of clothing as the hygiene product is being worn. Yet another separating paper 13, for example silicon paper, is arranged on the outermost side of the hot-melt adhesive 12 for protection of the hot-melt adhesive coating 12.

The fleece arrangements or hygiene products according to FIGS. 7 and 8 have a structure similar in principle to the fleece arrangement or the hygiene product according to FIG. 6. The essential difference between the fleece arrangements according to FIG. 7 or 8 and the fleece arrangement according to FIG. 6 is similar to the difference between the fleece arrangements according to FIGS. 5 and 4 or the difference between the fleece arrangements according to FIGS. 2 and 3. Otherwise expressed, this means that in favour of cost-effective manufacturing capacity as well as in favour of a lesser layer thickness the fleece arrangements according to FIGS. 7 and 8 also dispense with a separate spunbound cover layer 4, by means of which in any case the meltblown layer 3 of the fleece arrangements according to FIGS. 7 and 8 simultaneously takes on the tasks of cover layer 4 and collection layer 3.

A further difference between the fleece arrangements according to FIG. 7 or 8 and the fleece arrangement according to FIG. 6 is that not only the support fleece 9, but also the hot-melt layer 10 arranged on the support fleece 9 was folded around the outer edges of the product.

In spite of the omission of the separate cover layer 4 this leads to good discharge protection at the edges of the fleece arrangement.

The difference between the fleece arrangements according to FIG. 8 and FIG. 7 is that with the fleece arrangement according to FIG. 8 super absorber polymer powder 8 was applied not only on the hot-melt layer 10 as in FIG. 7, but that a dryblend composed of super absorber polymer powder 8 and hot-melt powder 14 was applied to the hot-melt layer 10 during production of the fleece arrangement according to FIG. 8. This has proven to be particularly advantageous for secure processing of the super absorber polymer application on the hot-melt layer 10.

Alternative embodiments of fleece arrangements are illustrated in FIGS. 9 to 13. These are characterised in particular in that a support fleece 9 was completely dispensed with, whereby the carrier layer is still formed only by the hot-melt film 10 itself. This, too, leads to the omission of otherwise necessary manufacturing processing steps and to the omission of the support fleece 9 and thus advantageously reduces both manufacturing costs and the thickness of the resulting hygiene product.

The embodiments according to FIGS. 9 and 10 are similar in their simplified structure without separating cover layer 4 and collection layer 3 to the embodiments in particular according to FIG. 3, 7 or 8. As compared to the embodiments according to FIG. 3, 7 or 8 however it is not the support fleece 9 absent here, but rather each cover layer 3 or 4 which is folded around the lateral edges of the product in the embodiments according to FIGS. 9 and 10. In this respect the embodiments according to FIGS. 9 and 10 correspond substantially to the diagrammatic illustration according to FIG. 5.

The difference between the embodiment according to FIG. 9 and the embodiment according to FIG. 10 is that with the fleece arrangement according to FIG. 9 the cover layer is formed by the somewhat stronger, hydrophilic meltblown-layer 3, which can be thermally bonded to the surface for improvement of the surface stability. In contrast, with the fleece arrangement according to FIG. 10 the cover layer comprises only the hydrophilic spunbonded fleece 4, resulting in particularly minimal thickness of a hygiene product so structured.

On the verso the fleece arrangements according to FIGS. 9 and 10 are again provided with a punctiform or strip hot-melt adhesive coating 12, and this ensures that each hygiene product cannot run off centre when being worn. A layer of separating paper 13, for example silicon paper, is arranged on the outermost side of the hot-melt adhesive coating 12 to protect the hot-melt adhesive 12.

With the fleece arrangements according to FIG. 11 or 12 the spunbound layer 4 of the SM cover layer 3, 4 is again folded around the lateral edges of the product to bring about good combining of the various layers and also to provide effective discharge protection at the edges of the product. Selective application of the super absorber polymer 8 acts as the latter likewise only in the middle surface area of the fleece arrangement, as does lateral tapering 11 of the meltblown-collection layer 3.

With the fleece arrangement according to FIG. 13 and for further simplification of the structure also the points or strips of the hot-melt adhesive coating 12 according to FIGS. 9 and 10 are omitted. The task of the hot-melt adhesive strip 12 is fulfilled in the embodiment according to FIG. 13 likewise by one and the same hot-melt coating 10, which at the same time also forms the support layer and takes on anchoring of the super absorber polymer 8 in the fleece arrangement. For this purpose in the embodiment according to FIG. 13 the hot-melt layer 10 comprises a contact hot-melt 10, whereof the surface also has a certain adhesiveness in the cooled state. In the embodiment according to FIG. 13 the rear surface of the contact-hot-melt layer 10 is also covered by a separating paper, which is peeled off before a corresponding hygiene product is used.

The fleece arrangement according to FIG. 13 on the one hand thus meets the highest demands for specific moisture absorption as well as discharge safety at a low weight and extremely minimal thickness, and on the other hand however can be manufactured almost without competition, since the fleece arrangement according to FIG. 13 comprises only a minimum of different layers.

The fleece arrangement according to FIG. 14 finally corresponds substantially to the layer structure of the fleece arrangement according to FIG. 2. However, the fleece arrangement according to FIG. 14 also has, in addition to the super absorber polymer arranged on the hot-melt layer 10, super absorber polymer particles 16, which are arranged in the region of the meltblown layer 3 of the fleece arrangement. In this respect the super absorber polymer particles 16 are placed on the fibres 15 of the meltblown-layer 3 or adhere to the fibres 15 of the meltblown-layer 3. In this way the absorption capacity and storage capacity of the fleece arrangement can be further improved, while the thickness of the fleece arrangement remains unchanged. Also, when it is under load the discharge safety is increased further still by adding the SAP particles to the microfibres of the meltblown 3.

In summary it becomes clear that due to the inventive fleece arrangements and due to the inventive process for manufacturing fleece arrangements important properties such as thickness, water vapour permeability, fluid density, fluid uptake, mechanical load-bearing capacity and wear comfort of highly absorptive hygiene articles, in particular slip inserts or napkins, are decisively improved. In the process the manufacturing costs of such fleece arrangements are not increased owing to the invention in spite of improved product properties, but can partially even be considerably reduced, in particular due to the inventive process.

1. A multi-layer fleece arrangement, in particular for absorptive hygiene articles, the fleece arrangement containing super absorber polymer and comprising a carrier layer, for example a support fleece, and a cover layer, characterised in that the fleece arrangement comprises a film of hot-melt film, whereby particulate super absorber polymer is arranged in certain places on the surface of the hot-melt film.

2. The fleece arrangement as claimed in claim 1, characterised in that the carrier layer is a PP, PET or PE spun or needle fleece, a watertight fleece or a micro-fibre fleece.

3. The fleece arrangement as claimed in claim 1, characterised in that the carrier layer is a spunbonded fleece made of PP, HDPE or LDPE with a surface weight of 8 to 80 g/m² is.

4. A multi-layer fleece arrangement, in particular for absorptive hygiene articles, the fleece arrangement comprising a carrier layer and a cover layer, characterised in that the carrier layer is formed by a film of hot-melt film.

5. The fleece arrangement as claimed in claim 4, characterised in that the hot-melt film is of the contact hot-melt type.

6. The fleece arrangement as claimed in claim 4, characterised in that the fleece arrangement contains super absorber polymer.

7. The fleece arrangement as claimed in claim 6, characterised in that the super absorber polymer is arranged particulate on the surface of the hot-melt film.

8. The fleece arrangement as claimed in claim 6, characterised in that the super absorber polymer is arranged in certain places on the surface of the hot-melt film.

9. The fleece arrangement as claimed in claim 1, characterised in that carrier layer and/or hot-melt film are hydrophobic.

10. The fleece arrangement as claimed in claim 1, characterised in that the hot-melt film is of the EVA, PA, PVAL or PUR type.

11. The fleece arrangement as claimed in claim 1, characterised in that the hot-melt film is vapour-tight.

12. The fleece arrangement as claimed in claim 1, characterised in that the hot-melt film is open to diffusion.

13. The fleece arrangement as claimed in claim 1, characterised in that the hot-melt film has at least a hydrophilic constituent.

14. The fleece arrangement as claimed in claim 1, characterised in that the coating weight of the hot-melt film is between 5 to 50 g/m².

15. The fleece arrangement as claimed in claim 1, characterised in that the cover layer comprises a hydrophilic micro-fibre fleece.

16. The fleece arrangement as claimed in claim 1, characterised in that as SM compound the cover layer is formed from hydrophilic spunbonded fleece with a preferred surface weight of 8 to 80 g/m² and from hydrophilic meltblown with a preferred surface weight of 10 to 100 g/m².

17. The fleece arrangement as claimed in claim 1, characterised in that the cover layer is imbued skin-friendly with softeners containing oil, wax or fat.

18. The fleece arrangement as claimed in claim 1, characterised in that the outer edges of the carrier layer or the cover layer at least in certain places form an edge envelope around the outer edges of the fleece arrangement.

19. The fleece arrangement as claimed in claim 1, characterised in that the super absorber polymer is present at least partially in the form of a natural product, in particular in the form of the crushed fruit of the Johannes bread tree.

20. The fleece arrangement as claimed in claim 1, characterised in that active carbon is added to the super absorber polymer.

21. The fleece arrangement as claimed in claim 1, characterised in that coked, pulverised bamboo is added to the super absorber polymer.

22. The fleece arrangement as claimed in claim 15, characterised in that the hydrophilic micro-fibre fleece comprises super absorber polymer.

23. The fleece arrangement as claimed in claim 22, characterised in that super absorber polymer particles are added to the fibres of the hydrophilic micro-fibre fleece.

24. A process for manufacturing a fleece arrangement having the procedural steps:
a) applying a hot-melt film to a carrier layer;
a′) selectively applying in certain places of super absorber polymer particles to the still sticky hot-melt film;
b) applying a cover layer to hot-melt film and super absorber polymer particles; and
c) cutting the fleece arrangement to size and joining of the layers.

25. A process for manufacturing a fleece arrangement having the procedural steps of:
a) applying at least of a layer of hot-melt film to a separating paper;
b) applying a cover layer to the hot-melt film; and
c) cutting the fleece arrangement to size and joining of the layers.

26. The process as claimed in claim 25, characterised in that super absorber polymer is introduced to the fleece arrangement or the starting material of the cover layer contains super absorber polymer.

27. The process as claimed in claim 26, characterised in that in a further procedural step a′) super absorber polymer is applied to the still sticky hot-melt film.

28. The process as claimed in claim 27, characterised in that the super absorber polymer is particulate.

29. The process as claimed in claim 27, characterised in that the super absorber polymer is arranged selectively in certain places on the hot-melt film.

30. The process as claimed in claim 27, characterised in that the super absorber polymer particles are applied in procedural step a′) by a pressure roller, in particular an engraving roller.

31. The process as claimed in claim 27, characterised in that the super absorber polymer particles are applied in procedural step a′) by electrostatic spraying.

32. The process as claimed in claim 24, characterised in that the cover layer in procedural step c) is a hydrophilic SM compound made of spunbonded fleece and meltblown.

33. The process as claimed in claim 24, characterised in that in a further procedural step c′) in between procedural steps b) and c) or after procedural step c) projecting edge regions of the carrier layer or the cover layer, forming an edge envelope, are folded around corresponding edge regions of the fleece arrangement.

34. The process as claimed in claim 24, characterised in that the layers are joined in procedural step c) by calendering.

35. The process as claimed in claim 24, characterised in that hot-melt contact adhesive and separating paper are applied on the rear side of the support layer.

36. The process as claimed in claim 24, characterised in that the procedural steps are carried out in regulated or continuous inline process.
